(19) United States
(12) Patent Application Publication
(10) Pub. No.: US 2004/0119436 A1
(43) Pub. Date: Jun. 24, 2004

(54) Method and apparatus for reducing countermass stroke with initial velocity

(76) Inventors: Michael Binnard, Belmont, CA (US); Kenji Nishi, Yokama-shi (JP)

Correspondence Address: McGuire Woods LLP, Suite 1800, 1750 Tysons Boulevard, Tysons Corner, McLean, VA, 22102-4215, US

(21) Appl. No.: 10/325,916

(22) Filed: Dec. 23, 2002

(51) Int. Cl. B64C 17/06

(52) U.S. Cl. 318/649

(57) ABSTRACT

A countermass stroke reduction assembly is provided. The assembly generally includes a base supporting one or more stages and first and second countermasses. Alternatively, first and second countermasses could be mounted separately from the base. The first and second stages move in one or more degrees of freedom. The countermasses move in at least one degree of freedom. In order to minimize the stroke of the countermasses, a drift velocity and y-intercept are determined off-line from an average position line for the countermass. An initial velocity equal in magnitude but opposite in sense to the drift velocity is then imparted to the countermass at the start of operation. Alternatively or additionally, an initial position offset equal and opposite to the y-intercept may be provided at the start of operation.

### BACKGROUND OF THE INVENTION

1. Field of the Invention

The present invention relates generally to semiconductor processing. More particularly, the present invention relates to an assembly and method for reducing countermass stroke in a wafer stage of a semiconductor processing.

2. Background Description

X-Y stages are well known, and are typically used in machine tools and other applications where two-dimensional precise movement is needed to position an object. An application of X-Y stages is in lithography equipment, such as, for example, in semiconductor processing. In this case, a stage may be used in a lithography tool to position in two dimensions the reticle (mask) or the wafer being processed. Such lithography tools typically include a source of radiant energy for illumination such as a mercury or other lamp, laser, or electron beam source, and a lens to focus the radiation, which passes through the reticle onto the workpiece (e.g., wafer). The lens is an optical lens in the case of photolithography, or an electron lens, which is an assembly of magnetic coils, in the case of an electron beam system.

It should be understood that the moving stage is often quite heavy and thus generates considerable reaction forces as it moves. To offset these reaction forces, lithography equipment sometimes employs the use of moving countermasses. However, known countermasses typically exhibit a drift velocity. Also, the stroke of the countermasses may be large in order to offset the reaction forces. This large stroke, of course, increases the size of the lithography equipment. Furthermore, the stroke of known countermasses is often not centered at the zero position.

### SUMMARY OF THE INVENTION

In a first aspect of the invention, a method is provided for reducing countermass stroke in an assembly comprising at least one moving stage and at least one countermass. The method includes determining a drift velocity v_{drift} for the at least one countermass and imparting an initial velocity −v_{drift} to the at least one countermass such that a net average velocity of the at least one countermass is substantially zero. In embodiments, the at least one countermass moves in one or more than one degree of freedom and an independent V_{drift} is compensated for each degree of freedom of the more than one degree of freedom.

In another aspect of the present invention, a method is provided for reducing countermass stroke in an assembly having the steps of determining a y-intercept yₒ of an average position line for the at least one countermass. The method of this aspect further includes applying an initial position offset of −yₒ to the at least one countermass thereby resulting in a countermass stroke centered at the zero position.

A system is also provided for reducing a stroke of at least one countermass in an assembly comprising means for determining a drift velocity v_{drift} of the at least one countermass and means for imparting an initial velocity −v_{drift} to the at least one countermass such that a net average velocity of the at least one countermass is substantially zero. In some embodiments, the at least one countermass is two countermasses and the at least one moving stage is two moving stages.

In still another aspect of the present invention, the system for reducing a stroke of at least one countermass in an assembly includes means for determining a drift velocity v_{drift} of the at least one countermass and means for imparting an initial velocity −v_{drift} to the at least one countermass such that a net average velocity of the at least one countermass is substantially zero. In embodiments, the system further includes means for determining a y-intercept yₒ of an average position line for the at least one countermass and means for imparting an initial position offset −yₒ to the at least one countermass such that a resulting countermass stroke is substantially centered at the zero position.

In yet another aspect of the present invention, a system for reducing countermass stroke includes a first and second countermass and a first and second guide bar having first and second stages disposed thereon, respectively. The first end of the first guide bar is mounted to the first countermass and the second end of the first guide bar is mounted to the second countermass. The first end of the second guide bar is mounted to the first countermass and the second end of the second guide bar is mounted to the second countermass. The first and second countermasses are common members for the first guide bar and the second guide bar in order to achieve conservation of the momentum for motions of the first guide bar and the second guide bar. A controller controls the first and second guide bars such that the following conditions are satisfied:

(i) a first reaction force (RF1) applied to the first countermass by movement of the first guide bar and a second reaction force (RF2) applied to the first countermass by movement of the second guide bar are approximately a same amount with opposite direction (RF1=-RF2); and

(ii) a third reaction force (RF3) applied to the second countermass by movement of the first guide bar and a fourth reaction force (RF4) applied to the second countermass by movement of the second guide bar are approximately a same amount with opposite direction (RF3=-RF4).

The countermass, in all embodiments, may move in one or more degree of freedom. In further embodiments, the system includes a stage assembly comprising a wafer stage supported by a base, an interferometer mirror IM, a wafer table supported on the wafer stage and a wafer chuck mounted on the wafer table. The wafer chuck is adapted to hold a wafer and the interferometer mirror IM. At least one isolator may support the base, and the wafer stage and wafer table may be capable of moving in multiple degrees of freedom.

### BRIEF DESCRIPTION OF THE DRAWINGS

FIG. 1 is a top view of an exemplary embodiment of a wafer stage according to the present invention;

FIG. 2 is a side view of an exemplary embodiment of a wafer stage according to the present invention;

FIGS. 3A and 3B are graphs of position versus time for two countermasses in a conventional control system;

FIGS. 4A and 4B are graphs of position versus time for two countermasses in a control system according to the present invention;

FIGS. 5A-5D show the results of a simulation using average velocity and average position compensation using the apparatus of the present invention;

FIGS. 6A-6D show the results of another simulation using the apparatus of the present invention;

FIG. 7 is a flow diagram showing the steps of the present invention;

FIG. 8 is a schematic view illustrating a photolithography apparatus according to the invention;

FIG. 9 is an exploded view of section A-A of FIG. 8;

FIG. 10 is a flow chart showing semiconductor device fabrication; and

FIG. 11 is a flow chart showing wafer processing.

### DETAILED DESCRIPTION OF A PREFERRED EMBODIMENT OF THE INVENTION

The embodiments of the present invention are directed to a method and apparatus capable of minimizing or reducing the countermass stroke of an apparatus with a moving stage during wafer processing. This feature is accomplished without requiring any change to the mechanical design or stage motion of the processing machinery such as, for example, lithographic machinery, or requiring any additional forces during the time when wafers are being processed. To accomplish these advantages, the present invention provides the countermasses an initial position offset and/or initial velocity that moves the average position line to zero.

### Countermass Stroke Reduction Assembly of the Present Invention

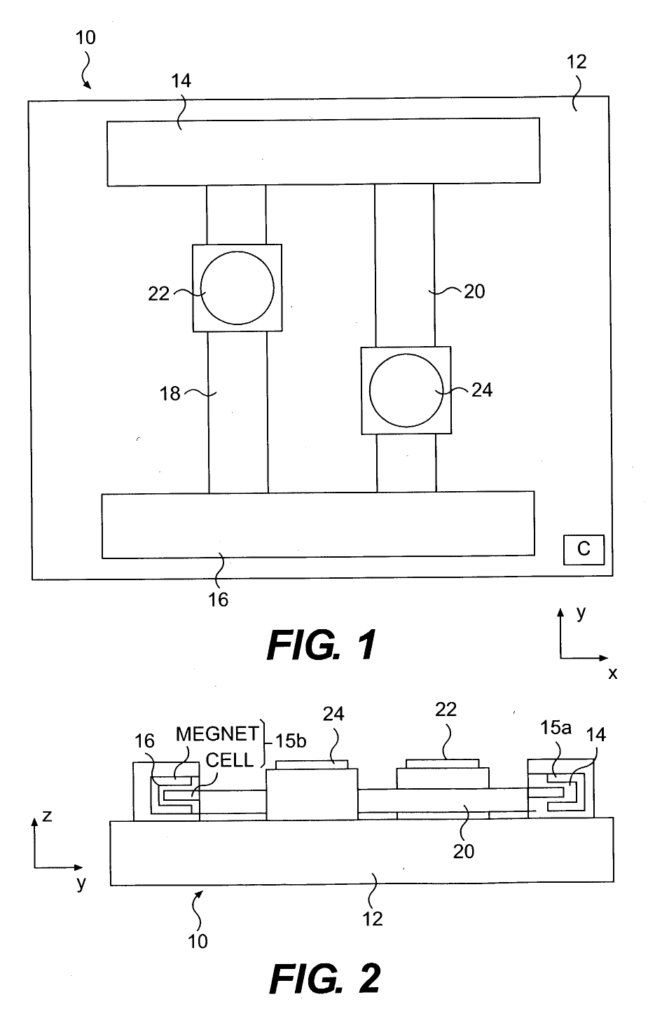

Referring now to the drawings, and more particularly to FIGS. 1 and 2, there is shown a countermass stroke reduction assembly 10 according to an exemplary embodiment of the invention. The assembly 10 generally includes a base 12, with first and second countermasses 14 and 16 and first and second guidebars 18 and 20 mounted thereon. It should be understood by one of ordinary skill in the art, however, that countermasses 14 and 16 may also be supported separately from the base 12. First and second wafer stages 22 and 24 are respectively disposed on first and second guidebars 18 and 20.

Each wafer stage 22 and 24 moves along its respective guidebar 18 and 20 in the y-direction, while guidebars 18 and 20 move in the x-direction. Guidebars 18 and 20 may be driven independently from each other in the x-direction, for example, by motors 15a and 15b (shown in FIG. 2). A part of the motors 15a and 15b are, in embodiments, attached to the countermasses 14 and 16, respectively. The motors 15a and 15b comprise a coil member attached to first and second guide bars 18 and 20, and a plurality of magnets attached to the first and second countermasses 14 and 16, respectively. Conversely, the coil member can be attached to the first and second countermasses 14 and 16, and the plurality of magnets attached to the first and second guide bars 18 and 20, respectively. The coil member and the magnets have a gap therebetween and are not contacting each other. The countermasses 14 and 16 are preferably heavier than the wafer stage 22 and 24 and the respective guide bar 18 and 20, and move in one degree of freedom (e.g., the x-direction).

It will be apparent to one skilled in the art that when guidebar 18 or 20 is moved in the positive x-direction, countermasses 14 and 16 will move independently in the negative x-direction. This negative x-direction movement of the countermasses 14 and 16 is due mainly because of the reaction force acting on the countermasses 14 and 16. The amount of motion of each countermass 14 and 16 depends on the y-position of wafer stage 22 and 24, since the y-position of wafer stage 22 and 24 affects the percentage of x-force required from each of the two motors. For example, when wafer stage 22 is near the first countermass 14 (as in FIGS. 1 and 2), a larger force is produced by the motor on the first countermass 14 than the motor on the second countermass 16. If the first and second countermasses 14 and 16 are of equal mass, the first countermass 14 will therefore move faster than the second countermass 16.

As thus shown in FIG. 1, the first stage 22 is disposed on the first guide bar 18, and the second stage 24 is disposed on the second guide bar 20. One end of the first guide bar 18 and the second guide bar 20 are mounted on the first countermass 14, and each of the other ends of the first guide bar 18 and the second guide bar 20 are mounted on the second countermass 16. The first and second countermasses 14 and 16 are common members for the first guide bar 18 and the second guide bar 20 to achieve conservation of momentum for the motions of the first guide bar 18 and the second guide bar 20. To minimize or reduce the countermass stroke, the guide bars 18 and 20 (and/or the first and second stages 22 and 24) are controlled by a controller C connected to the motors so that the following conditions may be satisfied:

1. The first reaction force (RF1) applied to the first countermass 14 by movement of the first guide bar 18 and the second reaction force (RF2) applied to the first countermass 14 by movement of the second guide bar 20 are approximately a same amount with opposite direction (RF1=-RF2).

2. The third reaction force (RF3) applied to the second countermass 16 by movement of the first guide bar 18 and the fourth reaction force (RF4) applied to the second countermass 16 by movement of the second guide bar 20 are approximately a same amount with opposite direction (RF3=-RF4).

According to the above sequence, the forces that are transmitted to each countermass and cause motion of the countermass cancel each other. Therefore, the countermass stroke can be minimized or reduced. Further, by combining the above sequence with the imparting of the initial velocity and/or offset value to at least one countermass, the countermass stroke can be minimized or reduced.

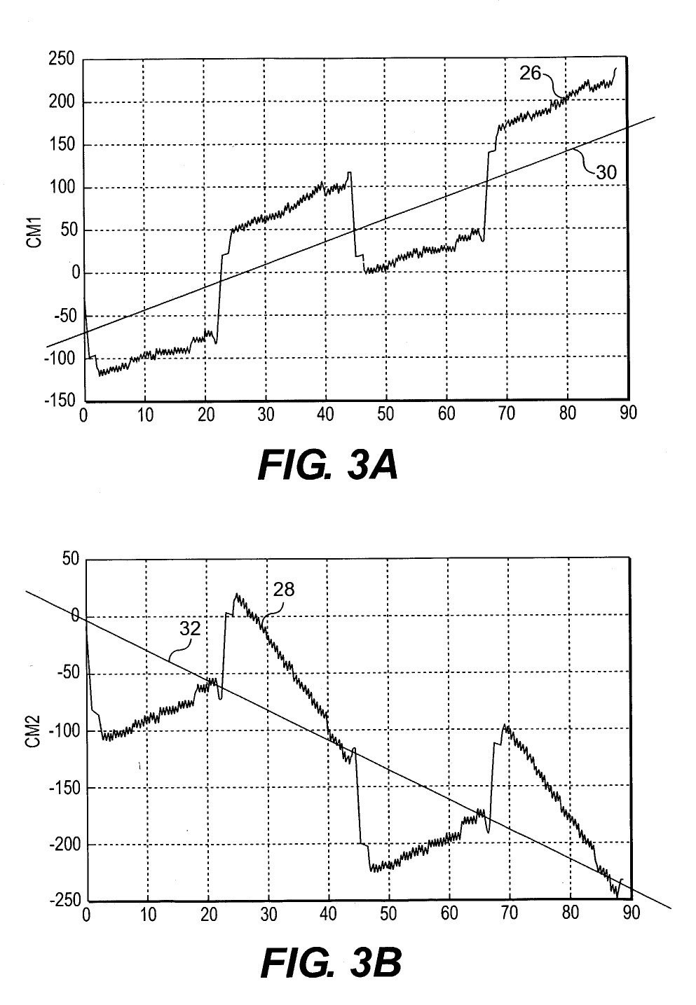

In order to determine the information on which to base initial velocity and/or position offset values, a simulation is conducted for countermasses 14 and 16 in a conventional control system. For example, Matlab® software from The MathWorks, Inc., may be used to perform such a simulation, as could any other mathematical or engineering modeling program (e.g., Working Model from MSC.Software Corporation, which may be linked to Matlab®). It is also contemplated that the initial velocity and/or position offset values may be determined empirically. The results of several simulations are shown in FIGS. 3A-4B and 6A-7D.

FIGS. 3A and 3B are distance versus time curves 26 and 28 for the two countermasses 14 and 16 during the exposure of four wafers in a conventional control system, simulated as described above. In such a conventional control system, the countermasses 14 and 16 are at 0 mm, with no velocity, at time t=0. The straight lines 30 and 32 in FIGS. 3A and 3B, respectively, show the average position of countermasses 14 and 16. It can be seen that the countermasses 14 and 16 exhibit some drift velocity (v_{drift}), which is the slope of the “average position” lines 30 and 32.

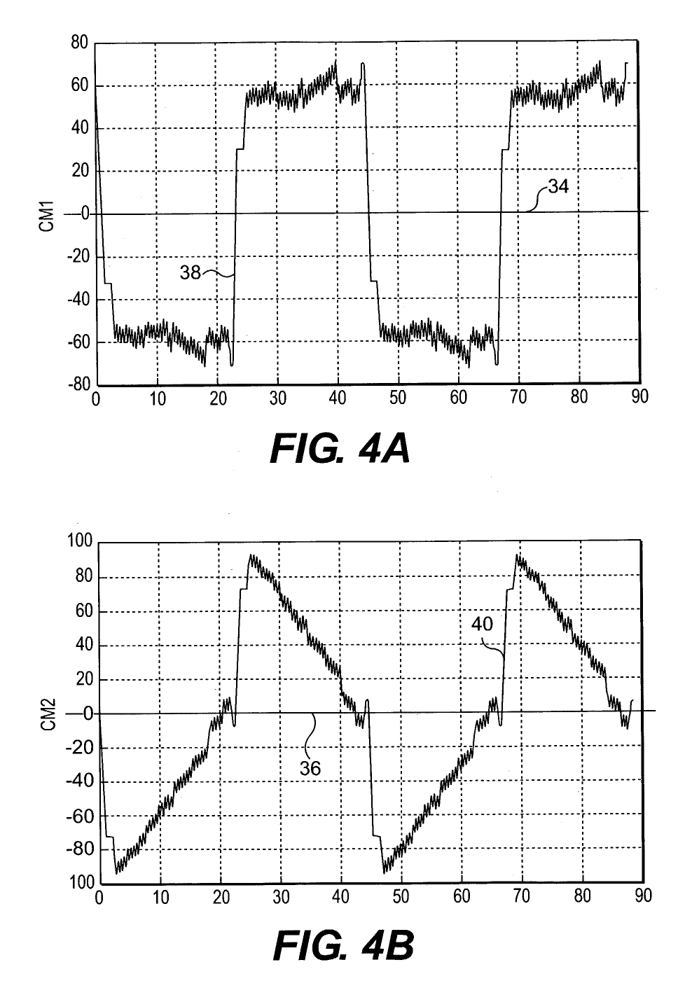

In a first aspect of the invention, an initial velocity is applied to the countermasses 14 and 16, such that at time t=0 countermasses 14 and 16 have velocities opposite the drift velocity shown in FIGS. 3A and 3B. Since countermasses 14 and 16 have velocity −v_{drift} at time t=0, and the stage motion imparts an average velocity change of v_{drift}, the net average velocity of countermasses 14 and 16 is zero, as shown by the slope of average position lines 34 and 36 in FIGS. 4A and 4B.

In a second aspect of the invention, countermasses 14 and 16 are offset from 0 mm at time t=0, as shown on position versus time plots 38 and 40 in FIGS. 4A and 4B, respectively. The amount of this offset is determined by taking the opposite of the y-intercept of the “average position” lines 30 and 32 in FIGS. 3A and 3B. As a consequence, the resulting countermass stroke is advantageously centered at 0 mm. It should be understood by those of ordinary skill in the art that the first and second aspect (i.e., the utilization of initial velocity or initial position offset) may be performed individually or together, depending on the particular application. It should also be appreciated by one of skill in the art that the times and distances shown in FIGS. 3A, 3B, 4A and 4B are by way of example only, and that other simulations will result when other countermasses or other stage motions are used in other systems. The plots are a function of the countermasses and the particular assembly in which they operate.

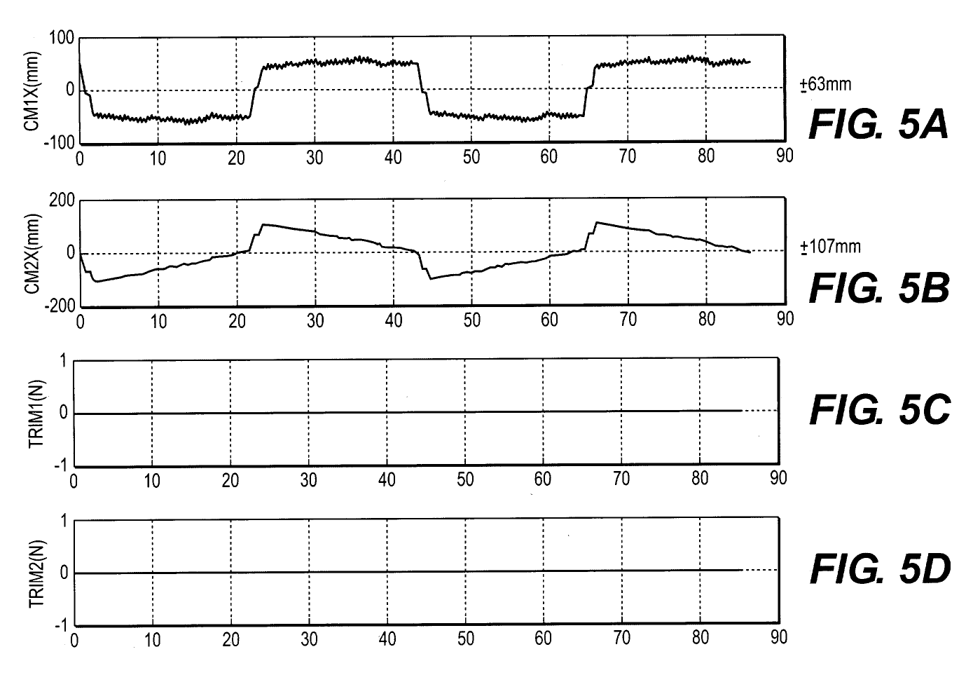

As should be apparent to one of ordinary skill in the art, the two countermasses are allowed to have different stokes. However, if a small DC trim force is applied (i.e., a constant force applied by a trim motor) to the countermasses to make the stroke equal, the maximum countermass stroke can be reduced. As seen in FIGS. 5A and 5B, results of a simulation using average velocity and average position compensation using the apparatus of the present invention is provided. In this simulation, no trim force is applied (FIGS. 5C and 5D). The graphs show the position of one countermass versus time. In FIGS. 5A and 5B, the stroke for the first countermass 14 is about +/−63 mm and the stroke for the second countermass 16 is about +/−107 mm. (The results of FIG. 5A are similar to that shown in FIG. 4A and the results of FIG. 5B are similar to that shown in FIG. 4B; however, the strokes in FIGS. 4A and 4B are slightly different because they are from a slightly different simulation. But, qualitatively the results of each simulation are equivalent). As should thus now be understood, by using the average position and average velocity compensation, each countermass moves back and forth within a fixed operating range, where the two ranges are different. In this case, the stroke for the second countermass 16 is larger than the stroke for the first countermass 14 because, on average, the stages are closer to the second countermass 16 than to the first countermass 14.

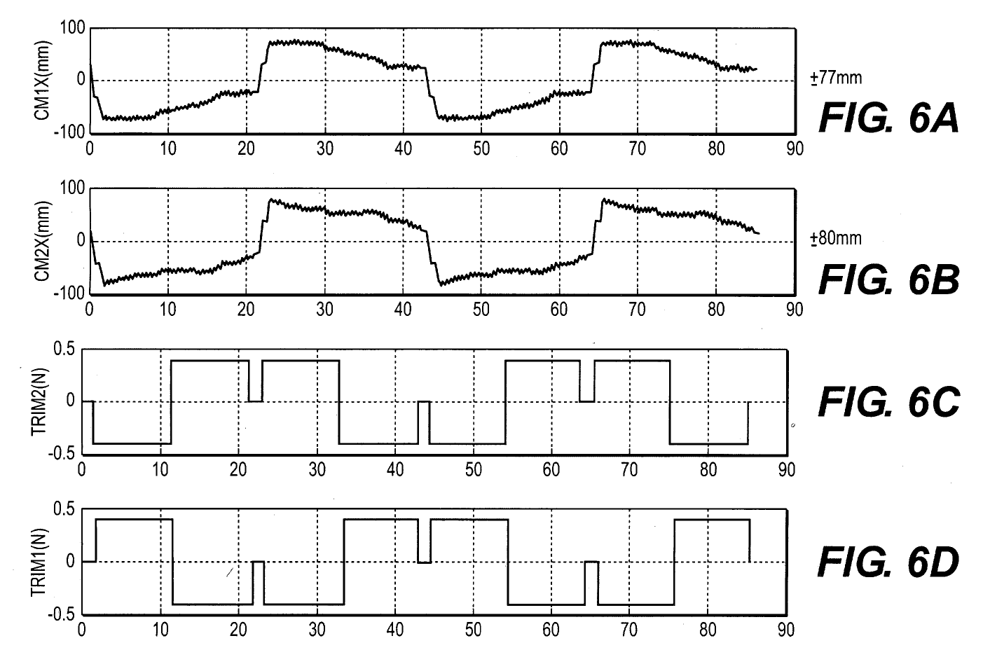

FIGS. 6A-6D show another simulation of the stroke with a trim force applied. Here, during each exposure, a small (about 0.4 N) trim force of equal but opposite force is applied to the countermasses to achieve both acceleration and deceleration. (FIGS. 6C and 6D.) The trim forces (i) keep the combined center of gravity of both stages constant and (ii) act to decelerate the second countermass 16 in a direction in order to cancel drift. It is noted that accelerating and decelerating forces are equal during exposure of a wafer so the countermass velocity at the end of exposure is the same as in FIG. 6B. (Only the position is changed.) As a result, both countermasses have a stroke of approximately +/−80 mm (i.e., the first and second countermasses are shown in FIGS. 6A and 6B to have strokes of approximately ±77 mm and ±80 mm, respectively). The benefit realized in this case is that the stroke of the second countermass has been reduced from ±107 to ±80 mm which, in turn, allows for a more compact lithography machine.

Because the trim forces are equal and opposite, the principle of conservation of momentum is maintained for the stage and countermass system. (Total externally-applied force is zero). This principle ensures that the position of the stage and countermass combined center of gravity does not move. For this reason, it is preferable to ensure that the trim forces are equal and opposite. Thus, this trim force can be applied to make the two countermasses have approximately the same maximum stroke. The trim forces are small, and should not be a big disturbance on the ground.

The trim force waveform can be determined from the simulation result in FIGS. 5A-5D. During the exposure processing of the first wafer (2-22 seconds) the first countermass has approximately zero average motion. The second countermass, on the other hand, moves almost 100 mm in this time. During exposure of the second wafer (24-44 seconds) the stages make the opposite motions. The trim motors are used to move the countermasses during these exposure periods. Each exposure period is divided into first and second halves. During the first half, a DC trim force is applied in one direction (in this case, the −X direction for the second countermass and the +X for the first countermass (i.e., one wants to move the second countermass in the −X and the first countermass in the +X directions)). During the second half, a DC trim force of the same magnitude is applied in the opposite direction. For example, from 2-12 seconds, the trim force on second countermass is negative, and from 12-22 seconds, the trim force on the second countermass is positive. Because the summation over each exposure time of the trim force applied to each countermass is zero, the effect of the trim force is to change the position of the countermass at the end of exposure, but not to change its velocity.

The magnitude of the trim force can be determined by the results shown in FIGS. 5A and 5B. During the first exposure period, the second countermass moves approximately 106 mm in the +X direction relative to the first countermass. To equalize the stroke of the countermasses, the second countermass is moved 53 mm in the −X direction, and the first countermass is moved 53 mm in the +X direction relative to the second countermass, and the countermasses are in approximately the same position for the start of processing for the second wafer. The amplitude of the force waveform can be calculated from this equation:

F=4Mx/t²,

where F is the force, M is the mass of the countermasses (assuming they are both the same mass), x is the desired displacement for each countermass (53 mm in this example), and t is the time available for the motion (20 sec).

The trim motor can be various type of actuators such as a linear motor utilizing a Lorentz force, an electromagnet, a rotary motor and son on. When the linear motor is used, a moving part of the linear motor can be connected to the countermass 126 and 18 and a fixed part (stator) of the linear motor can be connected to the base 12. The trim motor may be connected to the controller C and controlled by the controller C in accordance with the above manner based on a command signal for controlling the position of the stages 22 and 24.

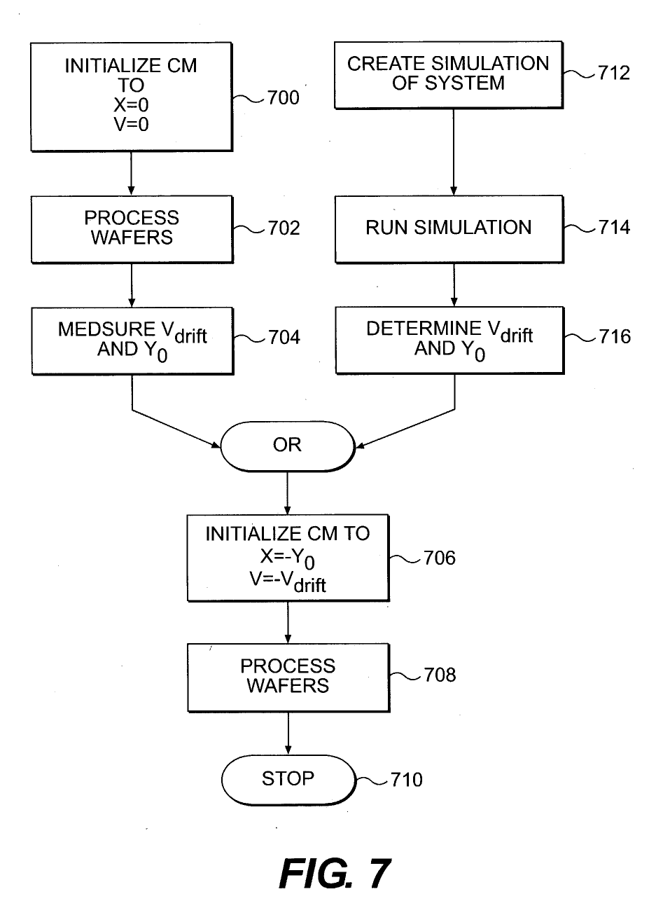

FIG. 7 shows a flow diagram of the different aspects of the present invention. The present invention may be implemented on computer program code in combination with the appropriate hardware. This computer program code may be stored on storage media such as a diskette, hard disk, CD-ROM, DVD-ROM or tape, as well as a memory storage device or collection of memory storage devices such as read-only memory (ROM) or random access memory (RAM). Additionally, the computer program code can be transferred to a workstation over the Internet or some other type of network. Alternatively, the computer program code can equally be hardwired into components for implementing the steps therein.

Specifically, in a first aspect, at step 700, the one or more countermass is initialized so that X=0, V=0. At step 702, test wafers are processed. At step 704, the V_{drift} and Y₀ are measured. At step 706, the countermass is initialized to X=Y₀, V=v_{drift}. At step 708, the wafer is processed. At step 710, the process stops. Alternatively, using a simulation, at step 712, a simulation for the system is created. (The simulation method (steps 712, 714, 716, 706, 708, 710) is preferred.) At step 714, the simulation is run, and at step 716, the V_{drift} and Y₀ are determined. Operation then proceeds with steps 706, 708 and 710. By using the steps illustrated above, countermass stroke can now be reduced.

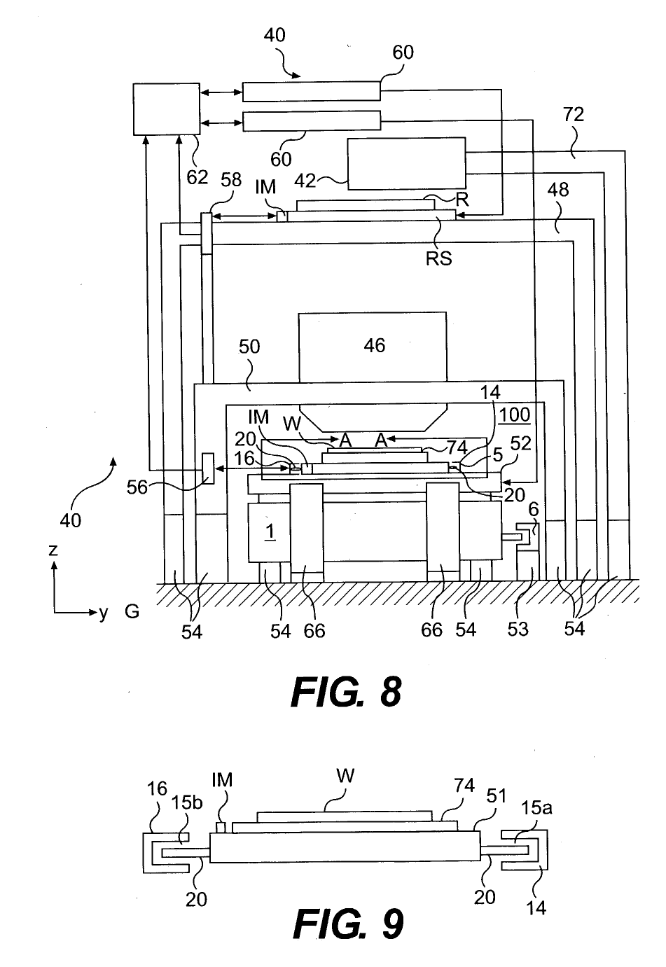

FIG. 8 is a schematic view illustrating a photolithography apparatus (exposure apparatus) 40 incorporating the present invention. A wafer positioning stage 52 includes a wafer stage 51, a base 1 and a wafer chuck 74 that holds a wafer W and an interferometer mirror IM. The base 1 is supported by a plurality of isolators 54 or, alternatively, may be on the ground or attached to the machine frame. An additional actuator 6 may be supported on the ground G though a reaction frame 53. Mounted to the wafer stage 51 are the first and second guide bars 18 and 20 and the first and second countermasses 14 and 16, respectively. (FIG. 9 is an exploded view of section A-A of FIG. 8 showing the wafer stage and chuck assembly.)

Still referring to FIG. 8, the wafer positioning stage 52 is structured so that it can move the wafer stage 51 in multiple (e.g., three to six) degrees of freedom under precision control by a drive control unit 60 and system controller 62, and position the wafer W at a desired position and orientation relative to the projection optics 46. A wafer table having three degrees of freedom (z, θₓ, θ_{y}) or six degrees of freedom can be attached to the wafer stage 51 to control the leveling and precision position of the wafer. The wafer table includes the wafer chuck 74, interferometer mirror IM, an actuator system, and a bearing system. The wafer table may be moved in the vertical plane by voice coil motors and supported on the wafer stage 51 by the bearing system (or other equivalent system) so that the wafer table can move relative to the wafer stage 51. The wafer positioning stage 52 incorporates the countermass stroke reduction assembly 10 described above. The reaction force generated by the motion of the wafer stage 51 at least in the x direction can be canceled by the motion of countermasses 14 and 16. Further, the reaction force generated by the motion of the wafer stage in the multiple degrees can be canceled by using at least one countermasses 14 and 16, as described above for each degree of freedom of the stage motion.

An illumination system 42 is supported by a frame 72 which projects radiant energy (e.g., light) through a mask pattern on a reticle R. The reticle R is supported by and scanned using a reticle stage RS. The reaction force generated by motion of the reticle stage RS can be mechanically released to the ground through a reticle stage frame 48 and the isolator 54, in accordance with the structures described in JP Hei 8-330224 and U.S. Pat. No. 5,874,820, the entire contents of which are incorporated by reference herein. The countermasses 14 and 16 may also be used with the reticle stage RS. The light is focused through a projection optical system (lens assembly) 46 supported on a projection optics frame 50 and connected to the ground through isolator 54.

An interferometer 56 is supported on the projection optics frame 50 and detects the position of the wafer stage 51 and outputs the information of the position of the wafer stage 51 in x, y, θₓ, θ_{y} and θz directions (FIG. 8 shows a part of measuring directions) to the system controller 62. A second interferometer 58 is supported on the projection optics frame 50 and detects the position of the reticle stage RS and outputs the information of the position to the system controller 62. The system controller 62 controls a drive control unit 60 to position the reticle R at a desired position and orientation relative to the wafer W or the projection optics 46.

It should be understood that there are number of different types of photolithographic devices which may be implemented with use by the present invention. For example, apparatus 40 may comprise an exposure apparatus that can be used as a scanning type photolithography system which exposes the pattern from reticle R onto wafer W with reticle R and wafer W moving synchronously. In a scanning type lithographic device, reticle R is moved perpendicular to an optical axis of projection optics 46 by reticle stage RS and wafer W is moved perpendicular to an optical axis of projection optics 46 by wafer positioning stage 52. Scanning of reticle R and wafer W occurs while reticle R and wafer W are moving synchronously in the x direction.

Alternately, exposure apparatus 40 may be a step-and-repeat type photolithography system that exposes reticle R while reticle R and wafer W are stationary. In the step and repeat process, wafer W is in a constant position relative to reticle R and projection optics 46 during the exposure of an individual field. Subsequently, between consecutive exposure steps, wafer W is consecutively moved by the wafer positioning stage 52 perpendicular to the optical axis of the projection optics 46 so that the next field of semiconductor wafer W is brought into position relative to the projection optics 46 and reticle R for exposure. Following this process, the images on reticle R are sequentially exposed onto the fields of the wafer W, and then the next field of semiconductor wafer W is brought into position relative to the projection optics 46 and reticle R.

However, the use of the apparatus 40 discussed herein is not limited to a photolithography system for semiconductor manufacturing. Apparatus 40 (e.g., an exposure apparatus), for example, may be used as an LCD photolithography system that exposes a liquid crystal display device pattern onto a rectangular glass plate or a photolithography system for manufacturing a thin film magnetic head. Further, the present invention can also be applied to a proximity photolithography system that exposes a mask pattern by closely locating a mask and a substrate without the use of a lens assembly. Additionally, the present invention provided herein can be used in other devices, including other semiconductor processing equipment, machine tools, metal cutting machines, and inspection machines.

In the illumination system 42, the illumination source can be g-line (436 nm), i-line (365 nm), KrF excimer laser (248 nm), ArF excimer laser (193 nm) and F₂ laser (157 nm). Alternatively, the illumination source can also use charged particle beams such as x-ray and electron beam. For instance, in the case where an electron beam is used, thermionic emission type lanthanum hexaboride (LaB₆) or tantalum (Ta) can be used as an electron gun. Furthermore, in the case where an electron beam is used, the structure could be such that either a mask is used or a pattern can be directly formed on a substrate without the use of a mask.

With respect to projection optics 46, when far ultra-violet rays such as the excimer laser is used, glass materials such as quartz and fluorite that transmit far ultra-violet rays are preferably used. When the F₂ type laser or x-ray is used, projection optics 46 should preferably be either catadioptric or refractive (a reticle should also preferably be a reflective type), and when an electron beam is used, electron optics should preferably comprise electron lenses and deflectors. The optical path for the electron beams should be in a vacuum.

Also, with an exposure device that employs vacuum ultra-violet radiation (VUV) of wavelength 200 nm or lower, use of the catadioptric type optical system can be considered. Examples of the catadioptric type of optical system include the disclosure Japan Patent Application Disclosure No. 8-171054 published in the Official Gazette for Laid-Open Patent Applications and its counterpart U.S. Pat. No. 5,668,672, as well as Japanese Patent Application Disclosure No. 10-20195 and its counterpart U.S. Pat. No. 5,835,275. In these cases, the reflecting optical device can be a catadioptric optical system incorporating a beam splitter and concave mirror. Japanese Patent Application Disclosure No. 8-334695 published in the Official Gazette for Laid-Open Patent Applications and its counterpart U.S. Pat. No. 5,689,377 as well as Japanese Patent Application Disclosure No. 10-3039 and its counterpart U.S. Pat. No. 5,892,117 also use a reflecting-refracting type of optical system incorporating a concave mirror, etc., but without a beam splitter, and can also be employed with this invention. The disclosures in the above-mentioned U.S. patents, as well as the Japanese patent applications published in the Office Gazette for Laid-Open Patent Applications are incorporated herein by reference.

Further, in photolithography systems, when linear motors that differ from the motors shown in the above embodiments (see U.S. Pat. Nos. 5,623,853 or 5,528,118) are used in one of a wafer stage or a reticle stage, the linear motors can be either an air levitation type employing air bearings or a magnetic levitation type using Lorentz force or reactance force. Additionally, the stage could move along a guide, or it could be a guideless type stage that uses no guide. The disclosures in U.S. Pat. Nos. 5,623,853 and 5,528,118 are incorporated herein by reference.

Alternatively, one of the stages could be driven by a planar motor, which drives the stage by electromagnetic force generated by a magnet unit having two-dimensionally arranged magnets and an armature coil unit having two-dimensionally arranged coils in facing positions. With this type of driving system, either one of the magnet unit or the armature coil unit is connected to the stage and the other unit is mounted on the countermasses 14 and 16.

Movement of the stages as described above generates reaction forces that can affect performance of the photolithography system. Reaction forces generated by the wafer (substrate) stage motion can be mechanically released to the floor (ground) by use of a frame member as described in U.S. Pat. No. 5,528,118 and published Japanese Patent Application Disclosure No. 8-166475. Additionally, reaction forces generated by the reticle (mask) stage motion can be mechanically released to the floor (ground) by use of a frame member as described in U.S. Pat. No. 5,874,820 and published Japanese Patent Application Disclosure No. 8-330224. The disclosures in U.S. Pat. Nos. 5,528,118 and 5,874,820 and Japanese Patent Application Disclosure No. 8-330224 are incorporated herein by reference.

As described above, a photolithography system according to the above described embodiments can be built by assembling various subsystems in such a manner that prescribed mechanical accuracy, electrical accuracy and optical accuracy are maintained. In order to maintain the various accuracies, prior to and following assembly, every optical system is adjusted to achieve its optical accuracy. Similarly, every mechanical system and every electrical system are adjusted to achieve their respective mechanical and electrical accuracies. The process of assembling each subsystem into a photolithography system includes mechanical interfaces, electrical circuit wiring connections and air pressure plumbing connections between each subsystem. Needless to say, there is also a process where each subsystem is assembled prior to assembling a photolithography system from the various subsystems. Once a photolithography system is assembled using the various subsystems, total adjustment is performed to make sure that every accuracy is maintained in the complete photolithography system. Additionally, it is desirable to manufacture an exposure system in a clean room where the temperature and humidity are controlled.

### Semiconductor Fabrication Processes Implemented with the Present Invention

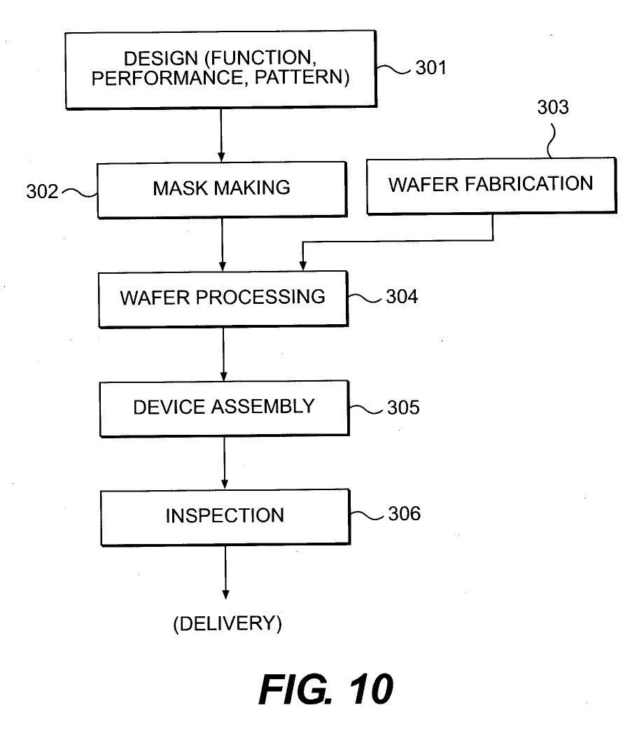

Semiconductor devices can be fabricated using the above described systems, by the process shown generally in FIG. 10. In step 301 the device's function and performance characteristics are designed. Next, in step 302, a mask (reticle) having a pattern is designed according to the previous designing step, and in a parallel step 303, a wafer is made from a silicon material. The mask pattern designed in step 302 is exposed onto the wafer from step 303 in step 304 by a photolithography system described hereinabove consistent with the principles of the present invention. In step 305, the semiconductor device is assembled (including the dicing process, bonding process and packaging process), then finally the device is inspected in step 306.

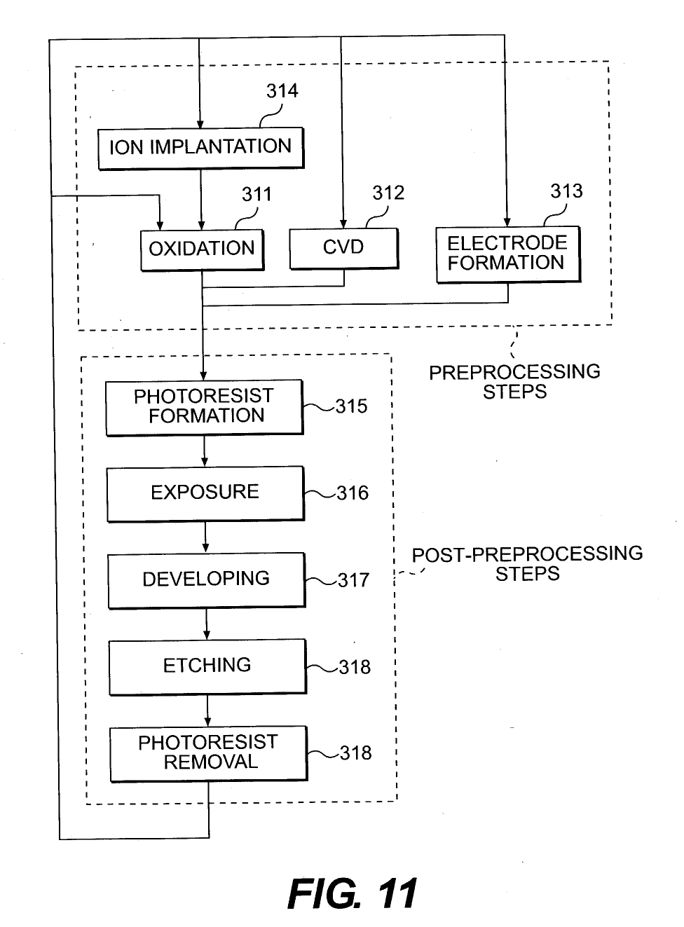

FIG. 11 illustrates a detailed flowchart example of the above-mentioned step 304 in the case of fabricating semiconductor devices. In step 311 (oxidation step), the wafer surface is oxidized. In step 312 (CVD step), an insulation film is formed on the wafer surface. In step 313 (electrode formation step), electrodes are formed on the wafer by vapor deposition. In step 314 (ion implantation step), ions are implanted in the wafer. The above-mentioned steps 311-314 form the preprocessing steps for wafers during wafer processing, and selection is made at each step according to processing requirements.

At each stage of wafer processing, when the above-mentioned preprocessing steps have been completed, the following post-processing steps are implemented. During post-processing, initially, in step 315 (photoresist formation step), photoresist is applied to a wafer. Next, in step 316 (exposure step), the above-mentioned exposure apparatus is used to transfer the circuit pattern of a mask (reticle) to a wafer. Then, in step 317 (developing step), the exposed wafer is developed, and in step 318 (etching step), parts other than residual photoresist (exposed material surface) are removed by etching. In step 319 (photoresist removal step), unnecessary photoresist remaining after etching is removed. Multiple circuit patterns are formed by repetition of these pre-processing and post-processing steps.

Accordingly, in a fabrication process using the assembly of the present invention, including a moving stage and at least one countermass and more preferably at least two countermasses (such as an assembly 10 of FIGS. 3A-3B), a reduction in the amount of stroke in the x-direction required for the countermass motion is achieved. Also, conservation of momentum in the x-direction is achieved, such that there is no force in the x-direction applied to the ground or the rest of the exposure apparatus. It should be appreciated that the results achieved by the countermass stroke reduction assembly 10 and shown in FIGS. 4A and 4B are superior, as the countermass position does not have any long term drift, and the amount of countermass stroke required is reduced. That is, by giving countermasses 14 and 16 an initial velocity and initial position offset, the average position line is moved to zero. This minimizes the countermass stroke without requiring any changes to the mechanical design or stage motion, or requiring any additional forces during the time when wafers are being processed.

While the invention has been described in terms of its preferred embodiment, those skilled in the art will recognize that the invention can be practiced with modifications within the spirit and scope of the appended claims. For example, one skilled in the art will recognize that, though a two-stage system is herein illustrated and described, the assembly 10 could equally be practiced in a single-stage system. Thus, it is intended that all matter contained in the foregoing description or shown in the accompanying drawings shall be interpreted as illustrative rather than limiting, and the invention should be defined only in accordance with the following claims and their equivalents.

What is claimed is:

1. A method of reducing countermass stroke in an assembly comprising at least one moving stage and at least one countermass, the method comprising the steps of:
determining a drift velocity v_{drift} for the at least one countermass; and
imparting an initial velocity −v_{drift} to the at least one countermass such that a net average velocity of the at least one countermass is substantially zero.

2. The method according to claim 1, wherein the assembly comprises at least two countermasses.

3. The method according to claim 1, wherein the countermasses move in one degree of freedom.

4. The method according to claim 1, wherein the at least one countermass moves in more than one degree of freedom and an independent V_{drift} is compensated for each degree of freedom of the more than one degree of freedom.

5. A method of reducing countermass stroke in an assembly comprising at least one moving stage and at least one countermass, the method comprising the steps of:
determining a y-intercept of an average position line for the at least one countermass; and
applying an initial position offset of the y-intercept to the at least one countermass thereby resulting in a countermass stroke centered at the zero position.

6. The method according to claim 5, wherein the assembly, comprises at least two countermasses.

7. The method according to claim 5, wherein the at least one countermass moves in one degree of freedom.

8. The method according to claim 5, wherein the at least one countermass moves in more than one degree of freedom.

9. A system for reducing a stroke of at least one countermass in an assembly comprising at least one moving stage and the at least one countermass, the system comprising:
a first controller for determining a drift velocity v_{drift} of the at least one countermass; and
a second controller for imparting an initial velocity −v_{drift} to the at least one countermass such that a net average velocity of the at least one countermass is substantially zero.

10. The system according to claim 9, wherein the at least one countermass is two countermasses and the at least one moving stage is two moving stages.

11. The system according to claim 9, wherein the system is a lithography system having one of a reticle and wafer stage.

12. The system according to claim 9, further comprising:
a third controller for determining a y-intercept of an average position line for the at least one countermass; and
a fourth controller for imparting an initial position offset of the y-intercept to the at least one countermass such that a resulting countermass stroke is substantially centered at the zero position.

13. The system according to claim 12, wherein the wafer stage includes a stage assembly comprising:
a wafer stage supported by a base;
an interferometer mirror IM; and
a wafer chuck mounted on the wafer stage, the wafer chuck adapted to hold a wafer.

14. The system according to claim 13, wherein the at least one countermass is two countermasses.

15. The system according to claim 13, wherein the at least one moving stage is two moving stages.

16. The system according to claim 13, wherein:
the wafer stage is capable of moving in multiple degrees of freedom, further comprising:
a wafer table capable of moving in multiple degrees of freedom; and
the wafer table is levitated in a vertical plane so that the wafer table can move relative to the wafer stage.

17. The system according to claim 9, wherein the at least one countermass moves in one degree of freedom.

18. The system according to claim 9, wherein the at least one countermass moves in more than one degree of freedom.

19. A system for reducing a stroke of at least one countermass in an assembly comprising at least one moving stage and the at least one countermass, the system comprising:
means for determining a drift velocity v_{drift} of the at least one countermass; and
means for imparting an initial velocity −v_{drift} to the at least one countermass such that a net average velocity of the at least one countermass is substantially zero.

20. A system for reducing countermass stroke, comprising:
a first countermass;
a second countermass;
a first guide bar having a first stage disposed thereon, the first guide bar having a first end and a second end, the first end of the first guide bar being mounted to the first countermass and the second end of the first guide bar being mounted to the second countermass; and
a second guide bar having a second stage disposed thereon, the second guide bar having a first end and a second end, the first end of the second guide bar being mounted to the first countermass and the second end of the second guide bar being mounted to the second countermass, wherein
the first and second countermasses are common members for the first guide bar and the second guide bar in order to achieve conservation of momentum for motions of the first guide bar and the second guide bar.

21. The system of claim 20, further including a controller for controlling the first and second guide bars such that the following conditions are satisfied:
(i) a first reaction force (RF1) applied to the first countermass by movement of the first guide bar and a second reaction force (RF2) applied to the first countermass by movement of the second guide bar are approximately a same amount with opposite direction (RF1=-RF2).

22. The system of claim 21, wherein the controller further controls the first and second guide bars so that the following conditions are further satisfied:
(ii) a third reaction force (RF3) applied to the second countermass by movement of the first guide bar and a fourth reaction force (RF4) applied to the second countermass by movement of the second guide bar are approximately a same amount with opposite direction (RF3=-RF4).

23. An exposure apparatus, comprising:
an illumination system for projecting radiant energy through a mask pattern on a reticle R; and
a system for reducing a stroke of at least one countermass in an assembly comprising at least one moving stage and the at least one countermass, the radiant energy being projected on a wafer positioned on the at least one moving stage, the system comprising:
a first controller for determining a drift velocity v_{drift} of the at least one countermass; and
a second controller for imparting an initial velocity −v_{drift} to the at least one countermass such that a net average velocity of the at least one countermass is substantially zero.

24. A device manufactured by a lithographic process using the exposure apparatus of claim 23.

25. A wafer on which an image has been formed by the exposure apparatus of claim 23.
